(19) United States
(12) Patent Application Publication
(10) Pub. No.: US 2009/0099848 A1
(43) Pub. Date: Apr. 16, 2009

(54) EARLY DIAGNOSIS OF DEMENTIA

(76) Inventors: Moshe Lerner, Perah-Tikva (IL); Ofer Bahar, Tel-Mond (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/873,019

(22) Filed: Oct. 16, 2007

(51) Int. Cl. G10L 11/00

(52) U.S. Cl. 704/271; 704/E11.001

(57) ABSTRACT

The present invention is an innovative system and method for passive diagnosis of dementias. The disclosed invention enables early diagnosis of and assessments of the efficacy of medications for neural disorders which are characterized by progressive linguistic decline and circadian speech-rhythm disturbances. Clinical and psychometric indicators of dementias are automatically identified by longitudinal statistical measurements and track the nature of language change and/or patient audio features change using mathematical methods. According to embodiments of the present invention the disclosed system and method include multi-layer processing units wherein initial processing of the recorded audio data is processed in a local unit. Processed and required raw data is also transferred to a central unit which performs in-depth analysis of the audio data. The combined analysis enables the identification of the frequencies and nature of temporary relapses of linguistic decline, and provides essential data for diagnosing early stages of different types of dementias.

### FIELD OF INVENTION

The present invention relates in general to systems and methods for the diagnosis of diseases, more particularly it relates to systems and methods for diagnosing early stages of several types of dementias, which are also characterized by aphasia according to speech patterns analysis and additional indicators.

### BACKGROUND OF THE PRIOR ART

New types of treatments for different types of dementia, such as Alzheimer dementia (AD), Frontotemporal dementia (FTD), Primary Progressive Aphasia (PPA), Pick disease, and Huntington disease, depend on an early diagnosis. However, performing an early diagnosis is difficult using existing means since in the initial stages of the disease symptoms only appear on rare occasions. Existing tests are quite predictive with remarkable percentage of correctness, though the common disadvantage of them all is that the test are usually conducted only after the patient shows high levels of clinical symptoms.

Yoshimine, “Diagnostic system and portable telephone device”, Patent Application No. EP1477109 incorporated herein as if fully set forth herein, discloses a system which enables a patient to register his or her audible sound when he is in good health. On other occasions the patient may contact a medical institution and pronounce words through a mobile phone. The audible sound is stored in a storing portion for storing audible sound information of the patient and is processed by a computer that gives diagnosis.

Brauers at al, “Automated speech disorder detection method and apparatus”, Patent Application No. WO2006109268 incorporated herein as if fully set forth herein, discloses a speech disorder detection method that can be implemented as an automated dialog with a person suspect to suffer from a change in speech. The method comprises performing a language analysis on a pre-defined spoken language received from a person under test. The language analysis comprises statistical analysis of phoneme lengths and speaking rate. These language analysis results are compared with results of previous language analysis results obtained for the person under test. The apparatus can be implemented on a stand-alone personal computer (PC) such as a laptop computer, a set-top box connected to a television set, a dedicated stand-alone device or a PC controlled from a server via the an internet connection.

There is therefore a need for a system and a method which enable the longitude analysis of speech and detection of preliminary symptoms of aphasia. This system should preferably combine audio data of the speech patterns of the patient with other biological parameters. The proposed solution should be an easy to use technological system combining portable and stationary devices.

### SUMMARY OF INVENTION

Disclosed is a method for the passive diagnosis of progressive linguistic decline and circadian speech-rhythm disturbances of a patient indicating dementia and neural disorders. The method comprises the step of continuous audio analysis in the premises of the patient over variable periods of time, distinguishing the voice of the patient from all other recorded voices and noises and storing audio data of the audio recording of the voice of the patient in clusters. The method also includes the steps of analyzing utterances in the clusters of the voice of the patient, providing statistical information of utterances and speech patterns of the patient and identifying symptomatic patterns in the clusters of the voice of the patient.

The analysis may be performed using a mathematic data processing model such as Hierarchical Hidden Markov Model (HHMM). The analysis may include identifying characteristics of utterances, phonemes, syllables, expressed emotion and speech. Analyzing utterance characteristics may rely on identifying utterance energy, utterance timing, and utterance pitch. The speech characteristics may include identifying agrammatism, slow and labored speaking impaired articulation, literal paraphasias, neologisms, words finding pauses and hesitancy within speech, stuttered approximation of words, entropy of words, and high-reoccurring coupling of words.

The method may also include the steps of continuously monitoring biological parameters of the patient and continuously identifying fluctuations in the circadian rhythms of the biological parameters of the patient. The biological parameters may include body temperature, heartbeat rates and motion patterns.

The method may also include the steps of continuously monitoring breathing patterns of the patient during sleeping hours, continuously monitoring movement patterns of the patient during sleeping hours and continuously identifying fluctuations in circadian rhythms of the patient in accordance with the fluctuations in breathing patterns and the fluctuations in movement patterns.

The method may further include the step of identifying fluctuations in emotional speech in the clusters and in the fluency of predefined letters. The statistical information may be analyzed in accordance with any of the time periods: seconds, minutes, hours, days, weeks and months. The analysis may be performed by comparing the utterances and the speech patterns in the different time periods.

The method may also include the step of conducting active testing of the patient. The active testing may include voice testing and image testing.

Also disclosed is a system for the passive diagnosis of progressive linguistic decline and circadian speech-rhythm disturbances of a patient indicating dementia and neural disorders. The system comprises at least one local unit located at the premises of the patient performing continuous audio recording in the premises of the patient over long periods of time and conducting preliminary analysis of the audio recording. The system also comprises at least one central unit for gathering audio data from the local units, performing in-depth analysis of the audio recording and storing recorded and analyzed data, and a long-range data communication network for establishing periodic data transference of information between the local unit and the central unit.

The system may also include at least one mobile carry-on unit for audio recording of the patient whenever the patient is outside the range of audio reception of the local unit and a short-range communication network for establishing periodic data transference of information between the mobile unit and the local unit. The preliminary analysis nay include filtering the voice of the patient from all other voices and noises.

The local unit may further include a temporary memory unit for storing recorded and analyzed data for short periods of time. The system may also include a body temperature unit for continuously measuring fluctuations in the body temperature of the patient, a breathing measuring unit for continuously measuring fluctuations in the breathing patterns of the patient and a movement measuring unit for continuously measuring fluctuations in movement patterns of the patient.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of the principal components of embodiments of the present invention;

FIG. 2 is a schematic block diagram illustrating the principal components of the local units in accordance with embodiments of the present invention;

FIGS. 3 and 4 illustrate a flowchart of the processing of audio input performed by the local unit in accordance with embodiments of the present invention;

FIG. 5 illustrates a flowchart of audio input analysis performed in the central unit in accordance with embodiments of the present invention;

FIG. 6 is a schematic block diagram illustrating the principal components of mobile unit 100 in accordance with embodiments of the present invention; and

FIG. 7 illustrates a flowchart of the processing of voice and data inputs performed by a mobile unit in accordance with embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is an innovative system platform and method for passive diagnosis of dementias. The disclosed invention enables early diagnosis of and assessments of the efficacy of medications for neural disorders which are characterized by progressive linguistic decline and circadian speech-rhythm disturbances. Clinical and psychometric indicators of dementias are automatically identified by longitudinal statistical measurements and track the nature of language change and/or patient audio features change using mathematical methods like Hierarchical Hidden Markov Model (HHMM). According to embodiments of the present invention the disclosed system and method include multi-layer processing units wherein initial processing of the recorded audio data is processed in a local unit. Processed data is transferred to the central unit which performs in-depth analysis, required raw data is also transferred to a central unit which performs in-depth analysis of the audio data or examined manually. The combined analysis enables the identification of the frequencies and nature of temporary relapses of linguistic decline, and provides essential data for diagnosing early stages of certain types of dementias.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” he included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

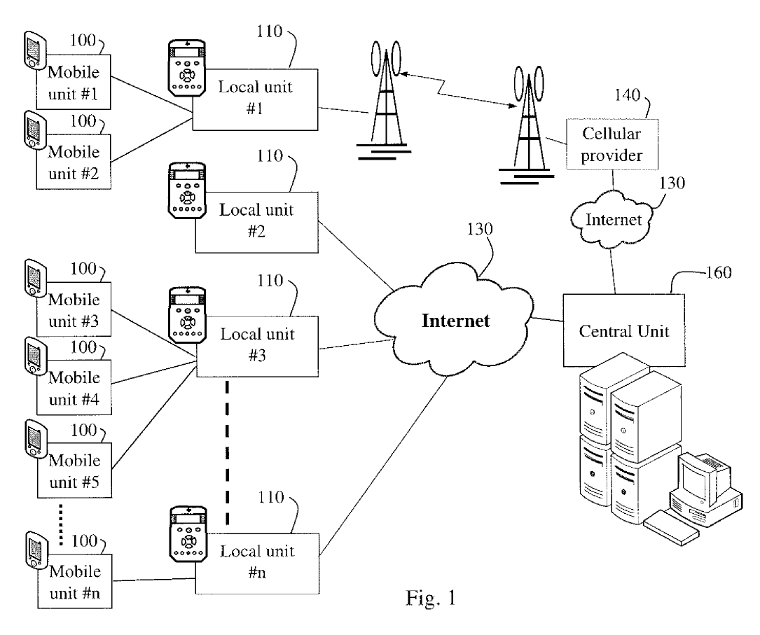

In order to perform the longitudinal voice statistical measurement embodiments of the present invention are composed of several elements. FIG. 1 is a schematic illustration of the principal components of embodiments of the present invention. According to embodiments of the present invention the disclosed system comprises a multiplicity of optional mobile units 100, wherein each of them communicates with at least one local unit 110. Each of the mobile units 100 performs audio recordings, and optionally also measurement of biological parameters such as body temperature, heartbeat rates, motion rates and the like. Communication between mobile units 100 and local unit 110 is performed through any type of wired or wireless connection. Each of the local unit 110 performs the level 1 analysis of the inputted audio and biological data. According to some embodiments, each of the local units 110 may also collect audio data in addition to collecting some of the biological parameters. Each of the local units 110 communicates with at least one central level 2 analysis computing unit 160. The communication between the local units 110 and the central computing unit 160 may be performed using any type of wireless or wired data communication method. For instance, the communication between the local units 110 and the central computing unit 160 may be performed via a Wide Area Network (WAN) system such as the internet 130, cellular communication network 140 or any combination thereof.

Local units 110 are installed in the residence of the patient or wherever the patient spends most of his or her waking hours on a daily basis. According to embodiments of the present invention, local units 110 may be sound-activated. Local units 110 record all audio input in their surroundings and perform initial analysis of the audio and biological data. For instance, based on voice recognition methods which are known to people who are skilled in the art, local units 110 identify the voice of the patient; all other voices, noises and sounds in the area are filtered out. Thus, only the speech uttered by the patient is recorded and analyzed by the proposed system and method.

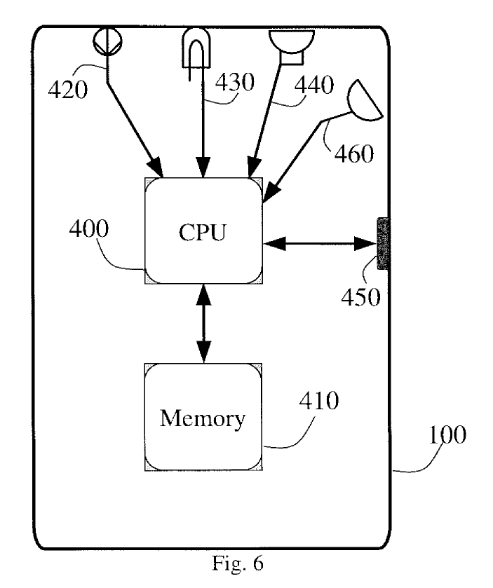

FIG. 6 is a schematic block diagram illustrating the principal components of mobile unit 100 in accordance with embodiments of the present invention. Mobile unit 100 includes a central processing unit (CPU) 400 which controls the storage and retrieval operations of the voice and biological data. According to embodiments of the present invention local unit 100 may include several local sensors such as microphones 440, temperature sensor 430, heartbeat rate sensor 420 and motion sensor 460. Communication between mobile unit and local unit is done through wired or wireless communication port 450. Mobile unit 100 may also include a storage device 410, such as an internal monolithic storage device.

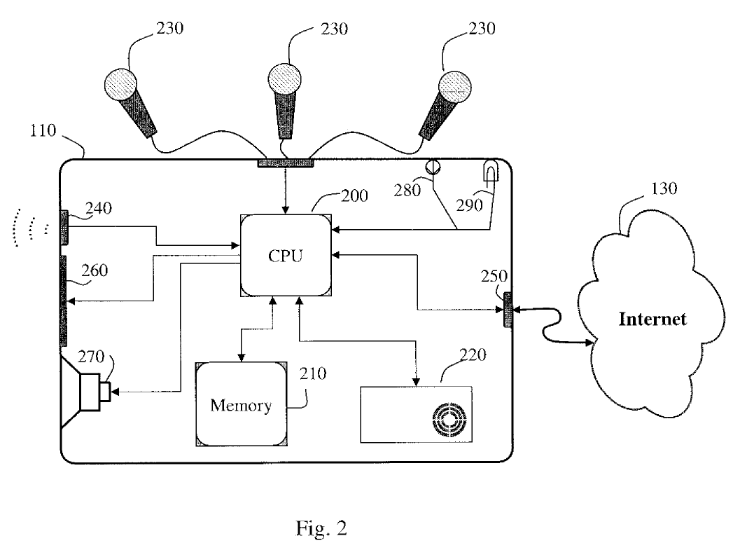

FIG. 2 is a schematic block diagram illustrating the principal components of local units 110 in accordance with embodiments of the present invention. Local units 110 include a local processing unit 200 which receives all incoming audio input from at least one microphone 230. According to embodiments of the present invention local unit 110 may connect to a plurality of microphones 230 positioned at different location within the residence of the patient. Communication between local unit 110 and microphones 230 may optionally be through any type of wired and wireless data communication apparatus or any combination thereof. In addition to audio input from microphones 230, processing unit 200 also receives audio data through local data communication port 240. Local data communication port 240 enables local unit 110 to receive audio data from any type of external recording device, such as mobile units 100 described herein. Local data communication port 240 may include any type of communication apparatus, including wireless communication means such as infrared, Zigbee, Bluetooth or other kind of ports in addition to any type of wired or connectors such as Universal Serial Bus (USB) or other standard serial ports. Local unit 110 may also include speaker 270 and display screen 260. Display screen 260 may be any type of screen such as a liquid crystal display (LCD) or Thin-film transistor (TFT) display. Display screen 260 may be used for communicating with the patient in an interactive test mode. Speaker 270 outputs a voice generated from a synthesized voice generator. Local unit 110 includes an internal power supply 220 for receiving external power and charging an internal battery. Communication of the local unit with the central unit is performed through communication port 250. Communication port 250 may include any type of communication apparatus, including wired, wireless, cellular and the like. According to embodiments of the present invention local unit 100 may also include several local sensors such as heartbeat rate sensor 280 and temperature sensor 290.

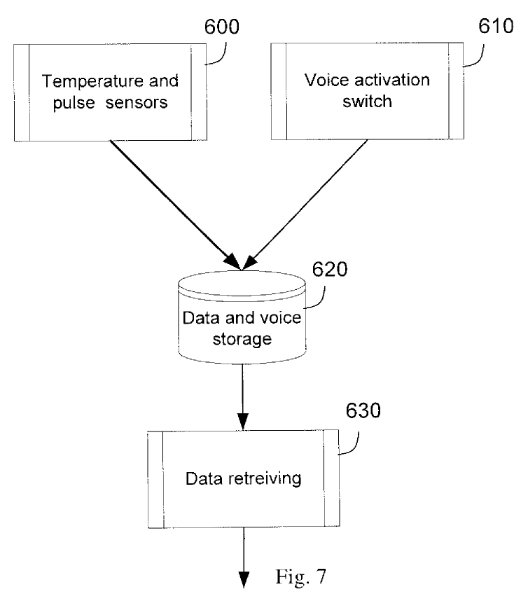

FIG. 7 illustrates a flowchart of the processing of voice and data inputs performed by mobile unit 100 in accordance with embodiments of the present invention. The process starts with collection of biological data (step 610) and selective voice data using voice activating switch (step 600). Next, the data is stored in the local monolithic memory (step 620). Then the data is retrieved by an external host device (step 630).

As mentioned above, local processing unit 200 performs a preliminary processing of audio and biological input. For instance, as aforementioned, local processing unit 200 filters out all voice and noise audio input segments which do not contain the voice of the patient. All audio input segments which include the voice of the patient are temporarily stored in storing unit 210. Additionally, local processing unit 200 may also perform some initial content analysis of the audio input. Analysis by local processing unit 200 may include letter finding, emotional speak extraction, phoneme extraction and mapping, syllables extraction, environmental noise level and produce basic statistical data. For instance phonemes extraction and mapping may include using a statistical model for finding unknown phonemes, such as Hierarchical Hidden Markov Model (HHMM) and a language dependent dialect configuration analysis. Additionally, the processing performed in local processing unit 200 may also include utterance energy and timing, including identifying features such as center frequency and pitch frequency, first three formants, energy contour plateau edge points (−3 db from the peak), energy contour rising slope gradient and duration, number of energy contour rising slope per second, energy contour falling slope gradient and duration and number of energy contour falling slope per second.

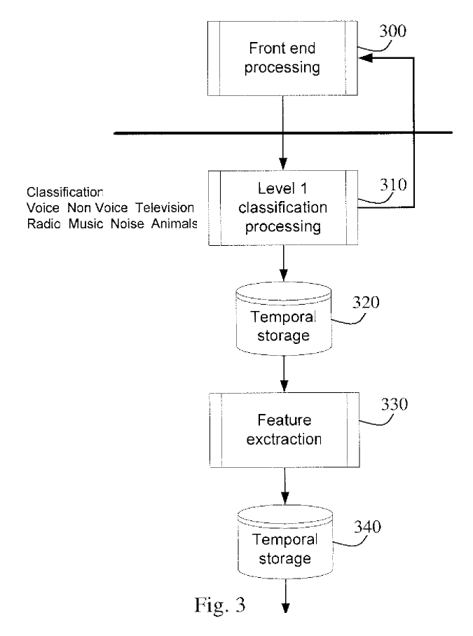

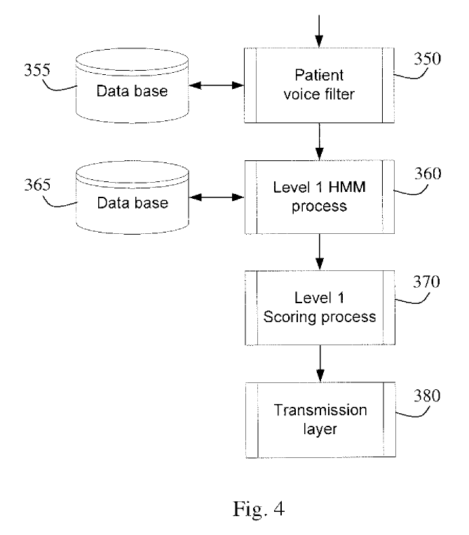

FIGS. 3 and 4 illustrate a flowchart of the processing of audio input performed by local unit 110 in accordance with embodiments of the present invention. The process starts with front-end processing (step 300) and level 1 classification process (step 310) which classifies all recorded audio input according to predetermined classifications such as distinguishing between voice and non-voice inputs, noises from electronic appliances such as the television and radio, music, simple noises and noises made by animals. The relevant audio input is then temporarily stored (step 320). Next, the process performs the features extraction procedure (step 330) and all data is temporarily stored (step 340). At the next step the voice of the patient is filtered (step 350) and stored (step 355). Then the HHMM procedure is performed (step 360) and its results are stored (step 365). Finally the level 1 scoring process is performed (step 370), extracting statistical data, and all data is prepared to be transmitted (step 380).

Referring back to FIG. 1, according to embodiments of the present invention, the system may also include mobile units 100 as supplementary components. Mobile units 100 are small portable devices which may be used as carry-on devices by the patients. Mobile units 100 enable the recording of the patients when the patients are away from their principle residence and store the recorded audio data on an internal monolithic storage unit. Upon predetermined self initiation or in response to a request from local unit 110, mobile device 100 connects to local unit 110 and transmits the stored data. Referring now to FIG. 2, communication between local unit 110 and mobile device 100 may be established using communication port 240. As mentioned above, the communication between local unit 110 and mobile device 100 may be performed through any type of wired or wireless communication means.

Periodically, local units 110 sends all processed and required raw data stored on its internal memory 210 to central level 2 analysis computing unit 160 in order to complete the full-scale analysis of the data. Local unit 110 may communicate with central unit 160 through any type of long-range communication means, such as a cellular network or the internet, by wireless or wire line means. The data can be sent from local unit 110 to central unit 160 by an initiative of local unit 110 or by a central unit 160 initiative. Central unit 160 manages the data transfer, data storage and data synchronization issues from all local units 110.

Following is a description of the processing performed by central unit 160 on preprocessed audio data collected by local units 110 in accordance with embodiments of the present invention. The analysis performed by central unit 160 may enable the detection of the following linguistic disorders in spontaneous speech: Agrammatism (i.e. telegram style) which is the reduction of sentences to a mere few words; slow and labored speaking within words and sentences; impaired articulation including wrong fluency or continuity of utterances within words; and literal paraphasias which includes sounds within words which are changed or left out. The analysis performed by central unit 160 may also include identifying neologisms, i.e. production of absolutely meaningless words, words finding pauses and hesitancy within speak, stuttered approximation of the word, entropy of words in different time frames, including hours, days, weeks, months. The algorithm may perform statistical clusters count including long term, mid term and short term analysis and search for letter fluency within each cluster. Additionally, the algorithm may include detection of disruption of circadian rhythms including detection of sundown syndrome, which manifests in exacerbation or agitation associated with the afternoon or evening hours, by using emotional speech detection. For this purpose the algorithm may identify utterances of anger, disgust, fear, happiness, sadness, non-emotional speech and boredom.

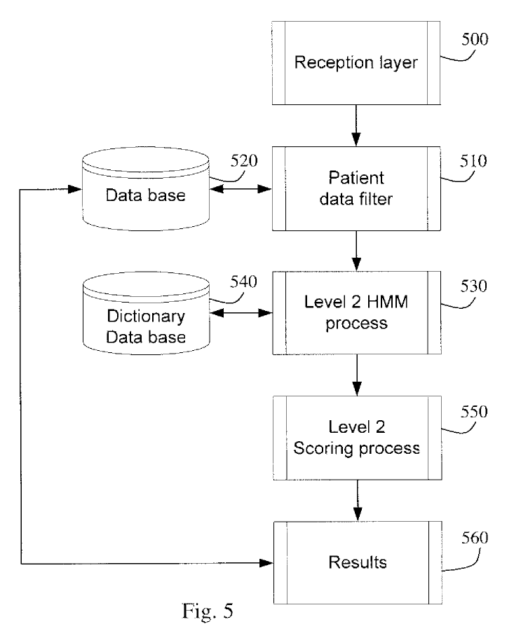

FIG. 5 illustrates a flowchart of audio input analysis performed in central unit 160 in accordance with embodiments of the present invention. First, the preprocessed audio input received from local units 110 is prepared for processing (step 500). Next, patient data is retrieved from a local data base which contains all other data of the patient (step 520). Then this data is combined with the incoming data (step 510), and stored back at the local data base (step 520). At the next step a level 2 HHMM algorithm is applied (step 530) using a dictionary database (step 540). Then, a level 2 scoring process which calculates the quality of the processed results is executed (step 550). Finally a high level statistical processing based on the previous output results and the filtered data from the data base is executed (step 560). The results are also stored in the database. In addition to identifying symptomatic utterances, the process enables the detection of symptomatic speech patterns, such as identifying the coupling of words repeating themselves relatively often and provide statistical analysis of all symptoms in long, mid, short term periods, including seconds, minutes, hours, days, weeks and so on.

According to embodiments of the present invention, central unit 160 may send local unit 110 feedback data according to the analysis performed by central unit 160. The feedback data may update the level 1 analysis procedures performed by local unit 110. This feedback is a result of the central unit processing and calculations, and may improve the analysis procedure of local units 110.

According to additional embodiments of the present invention the proposed system and method may also collect data concerning the body temperature, heartbeat rate, breathing patterns and motion of the patient, using standard measurement devices with appropriate communication interfaces to local unit 110 or mobile unit 100. This information may perform as supplementary data to the audio data analysis and improve the quality of the final results. For instance, based on this information the system may identify disruption of circadian rhythms, sleep-wake disturbances, including snoring detection, breathing pattern disruptions, and sensing erratic movement of the patient during waking and sleeping hours. Monitoring the body temperature cycling enables the detection of temperature acrophase (time of peak) and temperature curve during 24 hour cycle.

Before the proposed system and method can start operating a training procedure should be done. In the training procedure the voice features of the patient are measured and there is a baseline reference to start with the regular operating mode of the system and method. According to embodiments of the present invention the training procedure may be performed by recording the patient speaking or reading a predefined text several times.

in addition to the passive operating mode, as described above, according to embodiments of the present invention the proposed system and method may also include active operating modes. When operating in an active mode, local unit 110 conducts interactive cognitive tests to the patient by using voice and/or image capabilities. These tests are used to evaluate the different types of memory deficits over time. In voice tests, the patient is being asked by a synthesized voice generator in local unit 110 to repeat a set of words or series of words (e.g. dog, cat, table etc.). Local unit 110 then extracts the voice features, phonemes and optionally additional features from the patient response. This information is sent to central unit 160 which may calculate the tests results. In an image test, the patient may be asked by a synthesized voice generator in local unit 110 to identify some basic images, to recall a set of images, or to describe a visual scenario shown on display 260 on local unit 110. Similarly to the voice test, this information is sent to central unit 160 for advanced processing and test result evaluation.

It is important to note that according to embodiments of the present invention all speech analyses may be language and dialect dependent. For this purpose on initiation, local unit 110 and central unit 160 are programmed to the language or languages and dialects spoken by the patient.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A method for the passive diagnosis of progressive linguistic decline and circadian speech-rhythm disturbances of a patient indicating dementia and neural disorders, said method comprising the step of:
continuous audio analysis in the premises of said patient over variable periods of time;
distinguishing the voice of said patient from all other recorded voices and noises;
storing audio data of said audio recording of said voice of the patient in clusters;
analyzing utterances in said clusters of said voice of said patient;
providing statistical information of at least one of the following: utterances of the patient, speech patterns of the patient;
identifying symptomatic patterns in said clusters of said voice of said patient.

2. The method of claim 1 wherein said analysis of said utterances further includes analysis of speech patterns of the patient.

3. The method of claim 1 wherein said analysis is performed using a mathematic data processing model.

4. The method of claim 3 wherein said mathematic model is Hierarchical Hidden Markov Model (HHMM).

5. The method of claim 1 wherein said analysis includes at least one of the following: utterance characteristics, phoneme characteristics, syllables characteristics, expressed emotion, speech characteristics.

6. The method of claim 5 wherein said utterance characteristics include at least one of the following: utterance energy, utterance timing, utterance pitch.

7. The method of claim 1 wherein said speech characteristics includes identifying at least one of the following: agrammatism, slow and labored speaking impaired articulation, literal paraphasias, neologisms, words finding pauses and hesitancy within speech, stuttered approximation of words, entropy of words, high-reoccurring coupling of words.

8. The method of claim 1 further including the steps of:
continuously monitoring biological parameters of said patient;
continuously identifying fluctuations in the circadian rhythms of said biological parameters of said patient.

9. The method of claim 8 wherein said biological parameters include at least one of the following: body temperature, heartbeat rates, motion patterns.

10. The method of claim 1 further including the steps of:
continuously monitoring breathing patterns of said patient during sleeping hours;
continuously monitoring movement patterns of said patient during sleeping hours;
continuously identifying fluctuations in circadian rhythms of said patient in accordance with at least one of the following: said fluctuations in breathing patterns, said fluctuations in movement patterns.

11. The method of claim 1 further including the step of identifying fluctuations in emotional speech in said clusters.

12. The method of claim 1 further including the step of identifying fluctuations in the fluency of predefined letters.

13. The method of claim 1 wherein said statistical information is analyzed in accordance with at least one of the following time periods: seconds, minutes, hours, days, weeks, months, wherein said analysis is performed by comparing said utterances and said speech patterns in said different time periods.

14. The method of claim 1 further including the step of conducting active testing of said patient.

15. The method of claim 12 wherein said active testing includes at least one of the following: voice testing, image testing.

16. A system for the passive diagnosis of progressive linguistic decline and circadian speech-rhythm disturbances of a patient indicating dementia and neural disorders, said system comprising:
at least one local unit located at the premises of said patient performing continuous audio recording in the premises of said patient over long periods of time and conducting preliminary analysis of said audio recording;
at least one central unit for gathering audio data from said local units, performing in-depth analysis of said audio recording and storing recorded and analyzed data:
a long-range data communication network for establishing periodic data transference of information between said local unit and said central unit.

17. The system of claim 16 further including:
at least one mobile carry-on unit for audio recording of said patient whenever said patient is outside the range of audio reception of said local unit;
a short-range communication network for establishing periodic data transference of information between said mobile unit and said local unit.

18. The system of claim 16 wherein said preliminary analysis includes filtering the voice of said patient from all other voices and noises.

19. The system of claim 16 wherein said local unit further includes a temporary memory unit for storing recorded and analyzed data for short periods of time.

20. The system of claim 16 wherein said analysis includes at least one of the following: utterance characteristics, phoneme characteristics, syllables characteristics, expressed emotion, speech characteristics.

21. The system of claim 20 wherein said utterance characteristics include at least one of the following: utterance energy, utterance timing, utterance pitch.

22. The system of claim 20 wherein said speech characteristics includes identifying at least one of the following: agrammatism, slow and labored speaking impaired articulation, literal paraphasias, neologisms, words finding pauses and hesitancy within speak, stuttered approximation of words, entropy of words, high-reoccurring coupling of words.

23. The system of claim 16 further including a body temperature unit for continuously measuring fluctuations in the body temperature of said patient.

24. The system of claim 16 further including a breathing measuring unit for continuously measuring fluctuations in the breathing patterns of said patient.

25. The system of claim 16 further including a movement measuring unit for continuously measuring fluctuations in movement patterns of said patient.
